(19) United States
(12) Patent Application Publication
(10) Pub. No.: US 2017/0192158 A1
(43) Pub. Date: Jul. 6, 2017

(54) BACKLIGHT UNIT AND AUTOSTEREOSCOPIC 3D DISPLAY DEVICE INCLUDING THE SAME

(71) Applicant: LG DISPLAY CO., LTD., Seoul (KR)

(72) Inventors: ChangHo LEE, PAJU-SI (KR); SeungChul LEE, GYEONGGI-DO (KR); HanSeok KIM, PAJU-SI (KR); SeongHwan JU, PAJU-SI (KR)

(73) Assignee: LG DISPLAY CO., LTD., Seoul (KR)

(21) Appl. No.: 15/370,798

(22) Filed: Dec. 6, 2016

(30) Foreign Application Priority Data
Dec. 30, 2015 (KR) 10-2015-0190022

(51) Int. Cl. F21V 8/00; H04N 13/04; G02B 27/22

(52) U.S. Cl. CPC G02B 6/0076; G02B 6/0068; G02B 27/2214; G02B 6/0036; H04N 13/0497; H04N 13/0404; H04N 13/0452; G09G 3/003

(57) ABSTRACT

A backlight unit and an autostereoscopic 3D display device including the same are discussed, in which a 3D image can be displayed without using a 3D light controller that includes a liquid crystal layer. The backlight unit according to an embodiment includes a 3D light guide plate including first light output patterns and lenticular lenses, first light sources irradiating light to at least one side of the 3D light guide plate, a 2D light guide plate arranged below the 3D light guide plate, and second light sources irradiating light to at least one side of the 2D light guide plate. The lenticular lenses are arranged on the 3D light guide plate.

### CROSS REFERENCE TO RELATED APPLICATIONS

This application claims the priority benefit of the Korean Patent Application No. 10-2015-0190022 filed on Dec. 30, 2015, which is hereby incorporated by reference for all purposes as if fully set forth herein.

### BACKGROUND OF THE INVENTION

Field of the Invention

The present invention relates to a backlight unit and an autostereoscopic 3D (three-dimensional) display device including the same.

Discussion of the Related Art

3D-image display devices for displaying 3D image (or stereopsis image) are categorized into a stereoscopic 3D display technique and an autostereoscopic 3D display technique. Recently, the two techniques have been commercialized. The stereoscopic 3D display technique is categorized into a polarizing stereoscopic 3D display technique and a shutter stereoscopic 3D display technique. The polarizing stereoscopic 3D display technique switchably displays polarized light of a left and right parallax image on a direct viewing type display device or a projector and displays a 3D image by using polarizing glasses. The shutter stereoscopic 3D display technique displays a left and right parallax image through time division and displays a 3D image by using shutter glasses.

The autostereoscopic 3D display technique displays a 3D image by forming a viewing zone at an optimal viewing distance by properly controlling light from pixels of a display panel. The viewing zone may include ‘x’ number of views (‘x’ is an integer of 2 or more).

The autostereoscopic 3D display technique requires a 3D light controller, such as a switchable barrier or a switchable lens, which controls light from pixels of a display panel by using a liquid crystal layer. The switchable barrier displays a 2D (two-dimensional) image in a 2D mode and a 3D image in a 3D mode by transmitting light from the pixels of a display panel in the 2D mode as it is by using the liquid crystal layer and partially shielding the light from the pixels of the display panel in the 3D mode. On the other hand, the switchable lens displays a 2D image in a 2D mode and a 3D image in a 3D mode by transmitting light from the pixels of a display panel in the 2D mode as it is by using a liquid crystal layer and refracting the light from the pixels of the display panel like a lens in the 3D mode. However, the 3D light controller such as the switchable barrier and the switchable lens has a problem in that the manufacturing cost is high due to the liquid crystal layer.

### SUMMARY OF THE INVENTION

Accordingly, the present invention is directed to a backlight unit and an autostereoscopic 3D display device including the same that substantially obviates one or more problems due to limitations and disadvantages of the related art.

An advantage of the present invention is to provide a backlight unit and an autostereoscopic 3D display device including the same, in which a 3D image can be displayed without using a 3D light controller that includes a liquid crystal layer.

Additional advantages and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a backlight unit according to the embodiment of the present invention comprises a 3D light guide plate including first light output patterns and lenticular lenses, first light sources irradiating light to at least one side of the 3D light guide plate, a 2D light guide plate arranged below the 3D light guide plate, and second light sources irradiating light to at least one side of the 2D light guide plate. The lenticular lenses are arranged on the 3D light guide plate.

In another aspect of the present invention, an autostereoscopic 3D display device comprises a display panel; and a backlight unit irradiating light to the display panel. The backlight unit includes a 3D light guide plate including first light output patterns and lenticular lenses, first light sources irradiating light to at least one side of the 3D light guide plate, a 2D light guide plate arranged below the 3D light guide plate, and second light sources irradiating light to at least one side of the 2D light guide plate. The lenticular lenses are arranged on the 3D light guide plate.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating an autostereoscopic 3D display device according to one embodiment of the present invention;

FIG. 2 is a circuit diagram illustrating a pixel of FIG. 1;

FIG. 3 is a perspective view illustrating a backlight unit of FIG. 1;

FIG. 4 is a perspective view illustrating an example of first light sources and a 3D light guide plate of FIG. 3;

FIGS. 5A to 5C are cross-sectional views illustrating an example of the backlight unit of FIG. 3;

FIG. 6 is an exemplary view illustrating a method for implementing a 3D image in a 3D mode according to an embodiment of the present invention;

FIGS. 7A and 7B are exemplary views illustrating light output of a backlight unit when a 3D light guide plate does not include lenticular lenses (FIG. 7A) and when the 3D light guide plate includes the lenticular lenses (FIG. 7B);

FIGS. 8A and 8B are exemplary views illustrating a 3D image displayed when a 3D light guide plate does not include lenticular lenses (FIG. 8A) and when the 3D light guide plate includes the lenticular lenses (FIG. 8B);

FIG. 9 is a one-side sectional view illustrating another example of the backlight unit of FIG. 3; and

FIG. 10 is a one-side sectional view illustrating another example of the backlight unit of FIG. 3.

### DETAILED DESCRIPTION OF THE INVENTION

Advantages and features of the present invention, and implementation methods thereof will be clarified through following embodiments described with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Further, the present invention is only defined by scopes of claims.

A shape, a size, a ratio, an angle, and a number disclosed in the drawings for describing embodiments of the present invention are merely an example, and thus, the present invention is not limited to the illustrated details. Like reference numerals refer to like elements throughout the specification. In the following description, when the detailed description of the relevant known function or configuration is determined to unnecessarily obscure the important point of the present invention, the detailed description will be omitted.

In a case where ‘comprise’, ‘have’, and ‘include’ described in the present specification are used, another part may be added unless ‘only˜’ is used. The terms of a singular form may include plural forms unless referred to the contrary.

In construing an element, the element is construed as including an error range although there is no explicit description.

In describing a position relationship, for example, when the position relationship is described as ‘upon˜’, ‘above˜’, ‘below˜’, and ‘next to˜’, one or more portions may be arranged between two other portions unless ‘just’ or ‘direct’ is used.

In describing a time relationship, for example, when the temporal order is described as ‘after˜’, ‘subsequent˜’, ‘next˜’, and ‘before˜’, a case which is not continuous may be included unless ‘just’ or ‘direct’ is used.

It will be understood that, although the terms “first”, “second”, etc. may be used herein to describe various elements, these elements should not be limited by these terms. These terms are only used to distinguish one element from another element. For example, a first element could be termed a second element, and, similarly, a second element could be termed a first element, without departing from the scope of the present invention.

Further, “X-axis direction”, “Y-axis direction” and “Z-axis direction” should not be construed by a geometric relation only of a mutual vertical relation, and may have broader directionality within the range that elements of the present invention may act functionally.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item.

Features of various embodiments of the present invention may be partially or overall coupled to or combined with each other, and may be variously inter-operated with each other and driven technically as those skilled in the art can sufficiently understand. The embodiments of the present invention may be carried out independently from each other, or may be carried out together in co-dependent relationship.

Hereinafter, the preferred embodiments of the present invention will be described in detail with reference to the accompanying drawings.

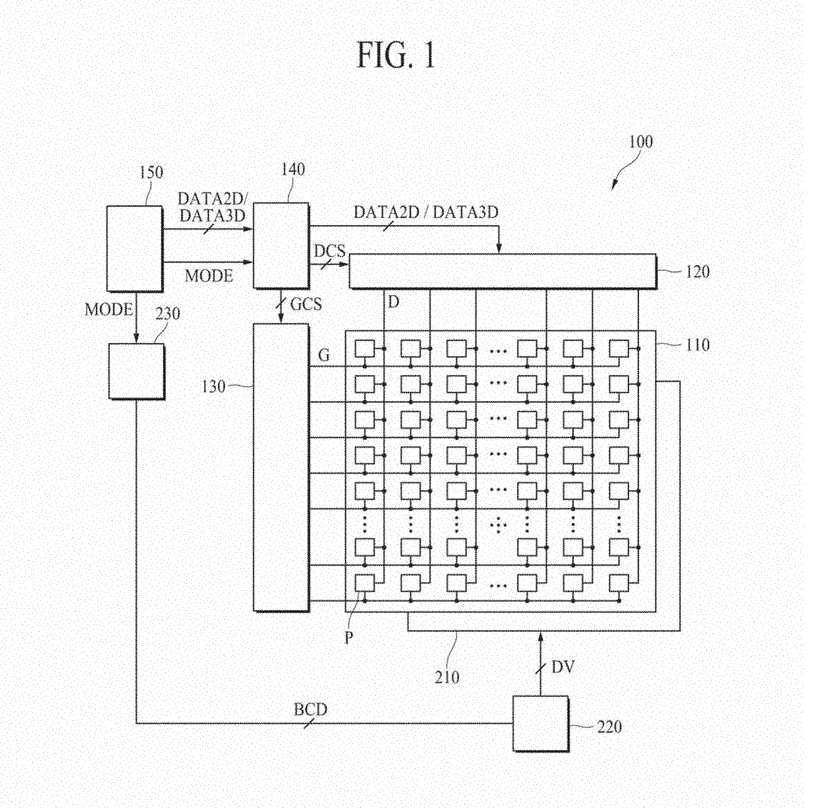

FIG. 1 is a block diagram illustrating an autostereoscopic 3D display device according to one embodiment of the present invention. Referring to FIG. 1, the autostereoscopic 3D display device 100 according to one embodiment of the present invention includes a display panel 110, a display panel driver, a display panel controller 140, a host system 150, a backlight unit 210, a backlight driver 220, and a backlight controller 230. All the components of the autostereoscopic 3D display device according to all embodiments of the present invention are operatively coupled and configured.

Since the autostereoscopic 3D display device 100 according to the embodiment of the present invention implements a barrier for displaying a 3D image by using a backlight unit 210, it is preferable that the autostereoscopic 3D display device 100 is implemented as a liquid crystal display device (LCD).

The display panel 110 displays an image by using pixels P. The display panel 110 includes a lower substrate, an upper substrate, and a liquid crystal layer interposed between the lower substrate and the upper substrate. Data lines D and gate lines G are formed on the lower substrate of the display panel 110. The data lines D may cross the gate lines G.

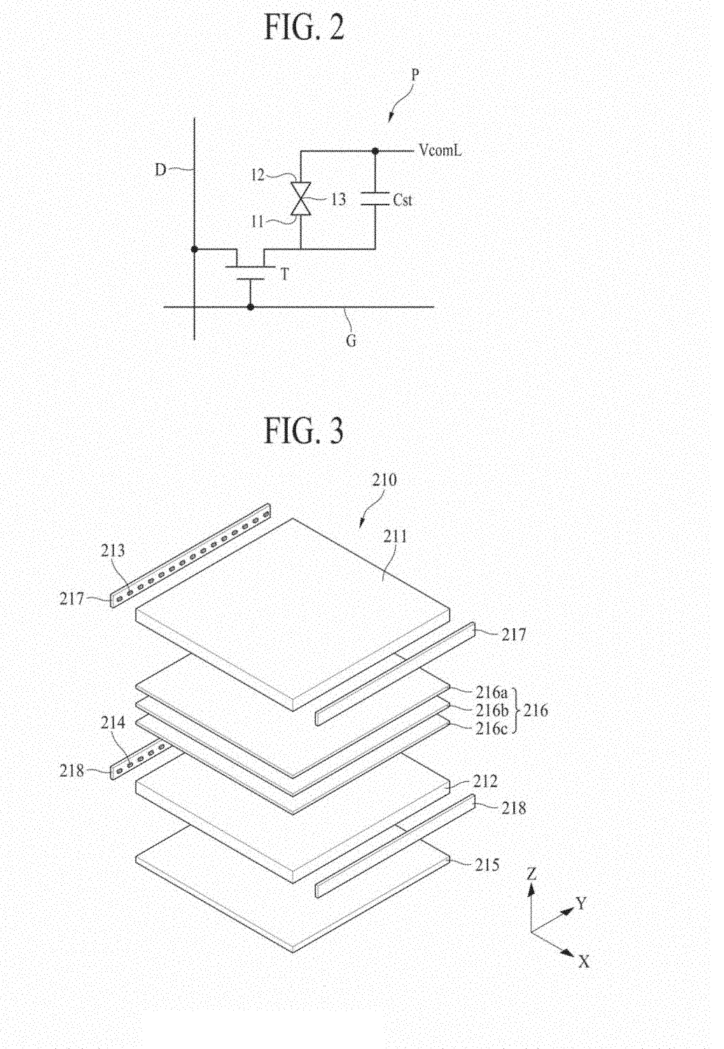

The pixels P may be formed at crossing portions between the data lines D and the gate lines G as shown in FIG. 1. Each of the pixels P may be connected to the data line D and the gate line G. Each of the pixels P may include a transistor T, a pixel electrode 11, a common electrode 12, a liquid crystal layer 13, and a storage capacitor Cst as shown in FIG. 2. The transistor T is turned on by a gate signal of the gate line G and supplies a data voltage of the data line D to the pixel electrode 11. The common electrode 12 is connected to a common line and supplied with a common voltage from the common line. For this reason, each of the pixels P may control transmittance of light from the backlight unit by driving liquid crystals of the liquid crystal layer 13 through an electric field generated by a potential difference between the data voltage supplied to the pixel electrode 11 and the common voltage supplied to the common electrode 12. As a result, the pixels P may display an image. Also, the storage capacitor Cst is provided between the pixel electrode 11 and the common electrode 12, and uniformly maintains the potential difference between the pixel electrode 11 and the common electrode 12.

The common electrode 12 is formed on the upper substrate in a vertical electric field driving mode such as a twisted nematic (TN) mode and a vertical alignment (VA) mode. The common electrode is formed on the lower substrate together with the pixel electrode in a horizontal electric field driving mode such as an in plane switching (IPS) mode and a fringe field switching (FFS) mode. Examples of a liquid crystal mode of the display panel 110 may include any mode as well as the TN mode, the VA mode, the IPS mode and the FFS mode.

A black matrix and color filters may be formed on the upper substrate of the display panel 110. The color filters may be formed at an opening which is not covered by the black matrix. If the display panel 10 is formed in a color filter on TFT (COT) structure, the color filters may be formed on the lower substrate of the display panel 110.

A polarizing pate may be attached to each of the lower substrate and the upper substrate of the display panel 110, and an alignment film for setting a pre-tilt angle of the liquid crystal may be formed. A column space for maintaining a cell gap of the liquid crystal layer may be formed between the lower substrate and the upper substrate of the display panel 110.

The display panel driver includes a data driver 120 and a gate driver 130.

The data driver 120 receives a data control signal DCS, 2D data DATA2D or 3D data DATA3D from the display panel controller 140. The data driver 120 may receive 2D data DATA2D in a 2D mode and receive 3D data DATA3D in a 3D mode. The data driver 120 converts the 2D data DATA2D or the 3D data DATA3D to positive polarity/negative polarity gamma compensation voltage in accordance with the data control signal DCS and generates analog data voltages. The analog data voltages output from source drive ICs are supplied to the data lines D of the display panel 110.

The gate driver 130 receives a gate control signal GCS from the display panel controller 140. The gate driver 130 generates gate signals in accordance with the gate control signal GCS and sequentially supplies the gate signals to the gate lines G of the display panel 110. Therefore, the data voltage of the data line D may be supplied to the pixel P to which the gate signals are supplied.

The display panel controller 140 receives the 2D data DATA2D from the host system 150 in the 2D mode, and receives the 3D data DATA3D from the host system 150 in the 3D mode. Also, the display panel controller 140 receives timing signals and a mode signal MODE from the host system 150. The timing signals may include a horizontal synchronization signal, a vertical synchronization signal, a data enable signal, and a dot clock. The display panel controller 140 may generate the gate control signal GCS and the data control signal DCS on the basis of the timing signals.

The display panel controller 140 supplies the gate control signal GCS to the gate driver 130, and supplies the data driver control signal DCS and the 2D data DATA2D or the 3D data DATA3D to the data driver 120. The display panel controller 140 may supply the 2D data DATA2D to the data driver 120 in the 2D mode and supply the 3D data DATA3D to the data driver 120 in the 3D mode.

The host system 150 supplies the 2D data DATA2D or the 3D data DATA3D to the display panel controller 140 through an interface such as a low voltage differential signaling (LVDS) interface and a transition minimized differential signaling (TMDS) interface. Also, the host system 150 supplies the mode signal MODE and the timing signals to the display panel controller 140, and supplies the mode signal MODE to the backlight controller 230. The mode signal MODE is a signal indicating which one of the 2D mode and the 3D mode corresponds to a current mode. For example, if the mode signal MODE has a first logic level voltage, the mode signal may be set to indicate the 2D mode, and if the mode signal MODE has a second logic level voltage, the mode signal may be set to indicate the 3D mode.

The autostereoscopic 3D display device generally needs a 3D light controller for displaying the 2D image displayed on the display panel 110 in the 2D mode as it is and displaying the 3D image displayed on the display panel 110 in the 3D mode in a viewing zone as a plurality of views. It is general that the 3D light controller controls light from the pixels of the display panel by using the liquid crystal layer in the same manner as the switchable barrier and the switchable lens. However, the 3D light controller such as the switchable barrier and the switchable lens has a problem in that the manufacturing cost is high due to the liquid crystal layer. In the embodiment of the present invention, since the backlight unit 210 serves as the 3D light controller, a separate 3D light controller is not required, whereby the manufacturing cost may be reduced.

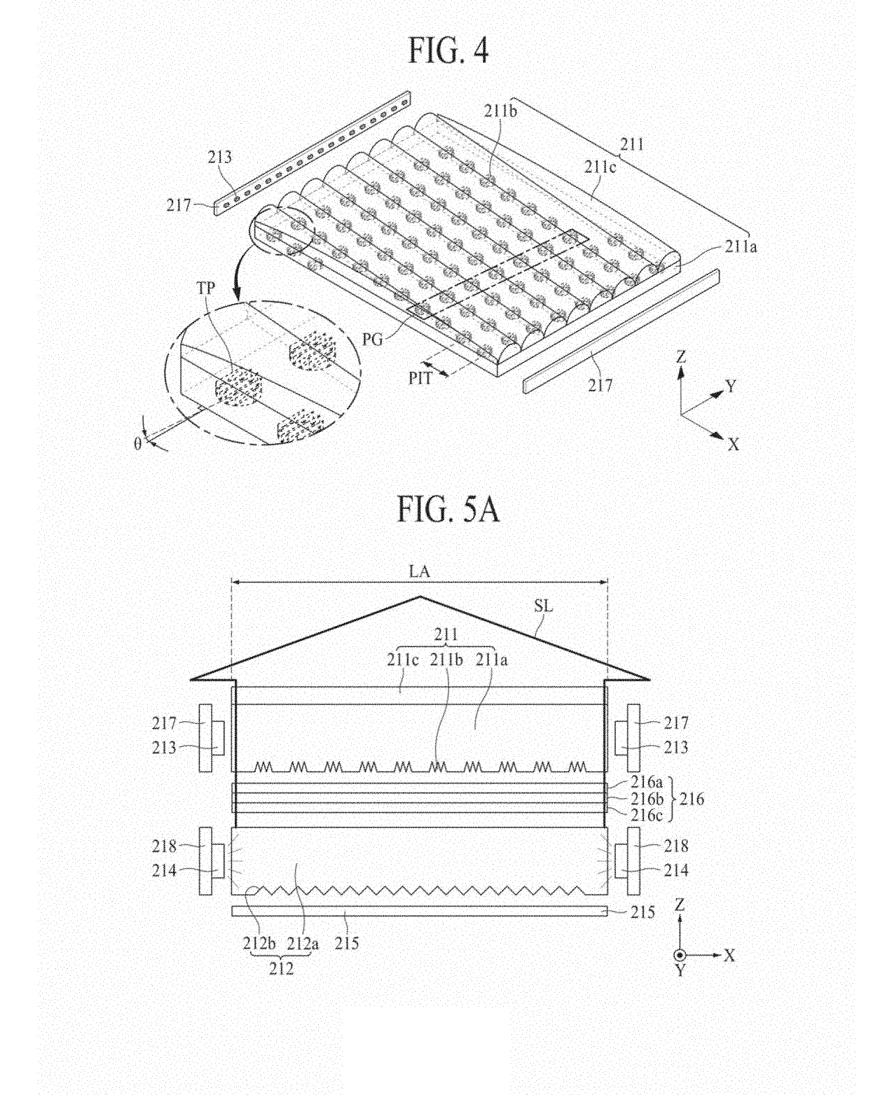

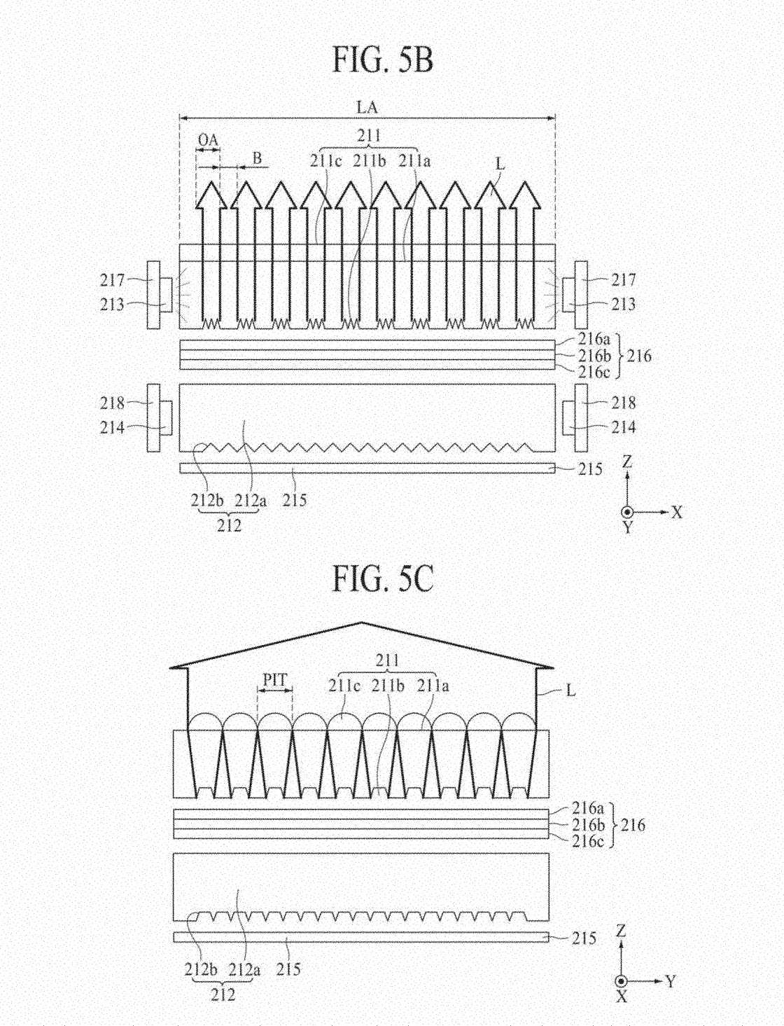

The backlight unit 210, as shown in FIGS. 4 and 5A to 5C, may include a 3D light guide plate 211 including first light output patterns 211b, a 2D light guide plate 212 including second light output patterns 212a, first light sources 213 irradiating light to the 3D light guide plate 211, and second light sources 214 irradiating light to the 2D light guide plate 212. If the first light sources 213 emit light, since light is emitted from the areas where the first light output patterns 211b are formed and is not emitted from the other areas, the backlight unit 210 may provide light to the display panel 110 to allow the other areas to serve as barriers. Also, the backlight unit 210 may provide uniform surface light to the display panel 110 if the second light sources 214 emit light. A detailed description of the backlight unit 210 will be described later with reference to FIG. 3.

The backlight driver 220 receives backlight control data BCD from the backlight controller 230. The backlight driver 220 generates a first driving current DC1 for emitting light from the first light sources 213 of the backlight unit 210 and a second driving current DC2 for emitting light from the second light sources 214 in accordance with the backlight control data BCD. The backlight driver 220 supplies the first driving current DC1 to the first light sources 213, and supplies the second driving current DC2 to the second light sources 214.

The backlight controller 230 receives the mode signal MODE from the host system 150. The backlight controller 230 generates the backlight control data BCD in accordance with the mode signal MODE and supplies the backlight control data BCD to the backlight driver 220, thereby controlling the backlight driver 220. The backlight control data may be transmitted in a serial peripheral interface (SPI) data format.

In more detail, the backlight controller 230 controls the backlight driver 220 to emit light from the second light sources 214 in the 2D mode. Therefore, the backlight driver 220 supplies the second driving current DC2 to the second light sources 214 in the 2D mode. The backlight controller 230 controls the backlight driver 220 to emit light from the first light sources 213 in the 3D mode. Therefore, the backlight driver 220 supplies the first driving current DC1 to the first light sources 213 in the 3D mode. Also, the backlight controller 230 may control the first and second light sources 213 and 214 at a predetermined duty ratio in the 2D mode and the 3D mode by considering response properties of the liquid crystal.

The backlight controller 230 may be included in the display panel controller 140. That is, the display panel controller 140 and the backlight controller 230 may be formed as one IC.

FIG. 3 is a perspective view illustrating the backlight unit of FIG. 1, and FIG. 4 is a perspective view illustrating an example of the first light sources and the 3D light guide plate of FIG. 3.

Referring to FIG. 3, the backlight unit 210 according to one embodiment of the present invention includes a 3D light guide plate 211, a 2D light guide plate 212, first light sources 213, second light sources 214, a reflective sheet 215, optical sheets 216, and first and second light source circuit boards 217 and 218.

The 3D light guide plate 211 is arranged on the uppermost of the backlight unit 210. The 3D light guide plate 211 may include a first light guide plate 211a, first light output patterns 211b, and lenticular lenses 211c.

The first light output patterns 211b may be arranged on a lower surface of the first light guide plate 211a as shown in FIG. 4. In this case, the first light output patterns 211b may be formed to be engraved on the lower surface of the first light guide plate 211a to allow light entering the 3D light guide plate 211 from the first light sources 213 to be output to the upper portion of the 3D light guide plate 211.

Each of the first light output patterns 211b may be a dot prism pattern. The dot prism pattern includes a plurality of trigonal prisms (TP), each of which may have a triangular shaped base as shown in FIG. 4. In this case, to output light entering the 3D light guide plate 211 from the first light sources 213 to the upper portion of the 3D light guide plate 211, the trigonal prisms may be formed to face the first light sources 213.

The first light output patterns 211b may be divided into a plurality of groups PG in accordance with a second direction crossing a first direction (Y-axis direction) along which the first light sources 213 are arranged. At each of the plurality of groups PG, the first light output patterns 211b may be arranged in accordance with a third direction crossing the second direction. The third direction may be a direction slanted at a predetermined angle with respect to one side of the 3D light guide plate 211. That is, at each of the plurality of groups PG, the first light output patterns 211b may be arranged in accordance with a third direction slanted at a predetermined angle with respect to one side of the 3D light guide plate 211. For this reason, 3D crosstalk may be minimized. The 3D crosstalk means that a left-eye image and a right-eye image are seen to a user by overlap, and a viewer may feel deterioration of picture quality of the 3D image due to the 3D crosstalk.

The lenticular lenses 211c may be arranged on the first light guide plate 211a as shown in FIG. 4. The lenticular lenses 211c may be formed on the first light guide plate 211a in an engraving pattern during manufacture of the 3D light guide plate 211. Alternatively, the lenticular lenses 211c may be attached to the first light guide plate 211a after being manufactured separately from the 3D light guide plate. Although the lenticular lens 211c is formed in a half-cylindrical lens type as shown, the lenticular lens 211c may be formed as a fresnel lens type without limitation to the half-cylindrical lens type.

Each pitch PIT of the lenticular lenses 211c may be arranged in parallel with the third direction, and a light axis LA may be arranged in parallel with a second direction. Preferably, the second direction and the third direction are orthogonal to each other.

At each of the plurality of groups PG, at least one of the first light output patterns 211b may be arranged at each pitch PIT of the lenticular lenses 211c. For example, as shown in FIG. 4, at each of the plurality of groups PG, one first light output pattern 211b may be arranged at each pitch PIT of the lenticular lenses 211c. Alternatively, at each of the plurality of groups PG, the plurality of first light output patterns 211b may be arranged at each pitch PIT of the lenticular lenses 211c.

The 2D light guide plate 212 is arranged below the 3D light guide plate 211. The 2D light guide plate 212 may include a second light guide plate 212a and second light output patterns 212b. The second light output patterns 212b may be formed on a lower surface of the second light guide plate 212a in an engraved pattern to allow light entering the 2D light guide plate 212 from the second light sources 214 to be output to the upper portion of the 2D light guide plate 212. The second light output patterns 212b may be formed, but not limited to, in a trigonal prism pattern as shown in FIG. 5A.

Particularly, the second light output patterns 212b may be fully formed on the lower surface of the second light guide plate 212a. For this reason, the light entering the 2D light guide plate 212 from the second light sources 214 may be output to the upper portion of the 2D light guide plate 212 as surface light. Also, the second light output patterns 212b may be arranged densely to output uniform surface light if the second light output patterns 212b become far away from the first light sources 213.

The first light sources 213 are arranged at both sides of the 3D light guide plate 211 and irradiates light to the 3D light guide plate 211. The second light sources 214 are arranged at both sides of the 2D light guide plate 212 and irradiates light to the 2D light guide plate 212. Although the first light sources 213 are arranged at both sides of the 3D light guide plate 211 and the second light sources 214 are arranged at both sides of the 2D light guide plate 212 in FIG. 3, the first light sources 213 and the second light sources 214 are not limited to the example of FIG. 3. That is, the first light sources 213 may be arranged at one side of the 3D light guide plate 211, and the second light sources 214 may be arranged at one side of the 2D light guide plate 212. The first and second light sources 213 and 214 may include any one or two types of light sources of a hot cathode fluorescent lamp (HCFL), a cold cathode fluorescent lamp (CCFL), an external electrode fluorescent lamp (EEFL), a light emitting diode (LED), and an organic light emitting diode (OLED).

Each of the first light sources 213 is packaged on the first light source circuit board 217, and may emit light by receiving a first driving current DC1 from the first light source circuit board 217. Each of the second light sources 214 is packaged on the second light source circuit board 218, and may emit light by receiving a second driving current DC2 from the second light source circuit board 218.

The reflective sheet 215 may be arranged below the 2D light guide plate 212. The reflective sheet 215 may reduce light loss by reflecting light, which is headed to the lower portion from the 2D light guide plate 212, toward the 2D light guide plate 212.

The optical sheets 215 may be arranged between the 3D light guide plate 211 and the 2D light guide plate 212 to output the light from the 2D light guide plate 212 to the display panel 10 as more uniform surface light. The optical sheets 215 may include at least one diffusion sheet and prism sheet. For example, the optical sheets 215 may include a diffusion sheet 216a, a prism sheet 216b, and a dual brightness enhancement film 216c as shown in FIG. 3.

FIGS. 5A to 5C are cross-sectional views illustrating an example of the backlight unit of FIG. 3. FIGS. 5A and 5B illustrate cross-sectional views when the backlight unit is viewed in the Y-axis direction of FIG. 3, and FIG. 5C illustrate a cross-sectional view when the backlight unit is viewed in the X-axis direction of FIG. 3. For convenience of description, the first and second light sources 213 and 214 are shown in FIG. 5C. Hereinafter, the output of light of the backlight unit 210 in the 2D mode will be described with reference to FIG. 5A, and the output of light of the backlight unit 210 in the 3D mode will be described with reference to FIGS. 5B and 5C.

Referring to FIG. 5A, the second light sources 214 emit light in the 2D mode, whereby the light enters the 2D light guide plate 212. In the 2D mode, the light from the second light sources 214 is output to the upper portion of the 2D light guide plate 212 by the second light output patterns 212b of the 2D light guide plate 212 as surface light SL. The light output to the upper portion of the 2D light guide plate 212 may be output as more uniform surface light SL through the optical sheets 216, and may enter the display panel 10 by passing through the 3D light guide plate 213 as it is.

Referring to FIGS. 5B and 5C, in the 3D mode, the first light sources 213 emit light, whereby the light enters the 3D light guide plate 211. In the 3D mode, the light from the first light sources 212 is output to the upper portion of the 3D light guide plate 211 by the first light output patterns 211b of the 3D light guide plate 211.

As shown in FIG. 5B, a pitch PIT of each of the lenticular lenses 211c is parallel with the third direction which is the arrangement direction of the first light output patterns 211b of each of the plurality of groups GP1 to GP5. If the first light output pattern 211b is arranged at a focal distance f of the lenticular lens 211c, the light L output to the upper portion of the 3D light guide plate 211 by the first light output pattern 211b is converted to linear light by the lenticular lens 211c. For this reason, in the 3D mode, the light L output to the upper portion of the 3D light guide plate 211 by the first light output patterns 211b parallel with the third direction may be output in a line type parallel with the third direction as shown in FIG. 5C.

The focal distance ‘f’ of the lenticular lens 211c may be calculated expressed by the following Equation 1.

$$\frac{1}{f} = ( n - 1 ) ( \frac{1}{{R}_{1}} - \frac{1}{{R}_{2}} ) \qquad [ Equation 1 ]$$

In Equation 1, ‘f’ denotes a focal distance, ‘n’ denotes a refractive index of the lenticular lens 211c, R1 denotes a curvature radius of a light emitting portion, and R2 denotes a curvature radius of a light incident portion. Meanwhile, as shown in FIG. 5C, since the light incident portion is in contact with the first light guide plate 211a, the curvature radius of the light incident portion is close to an infinite quantity. Therefore, Equation 1 may be summarized as expressed by the following Equation 2.

$$\frac{1}{f} = \frac{( n - 1 )}{{R}_{1}} \qquad [ Equation 2 ]$$

Finally, in order that the light L output to the upper portion of the 3D light guide plate 211 by the first light output pattern 211b is output in a line type parallel with the second direction, a thickness of the first light guide plate 211a may be designed considering the focal distance ‘f’ of Equation 2.

As shown in FIG. 5B, a light axis LA of each of the lenticular lenses 211c is parallel with the second direction. The first light output patterns 211b arranged in a third direction output light L from areas only where the first light output patterns 211b are arranged. That is, as shown in FIG. 5B, the first light output patterns 211b output light L from areas only where they are arranged, and hardly output light from areas between them. Therefore, in the 3D mode, the areas where the first light output patterns 211b are arranged serve as opening areas OA, and the areas between the first light output patterns 211b serve as barriers B.

As described above, in the embodiment of the present invention, if the second light sources 214 emit light to irradiate the light to the 2D light guide plate 212 in the 2D mode, uniform surface light may be provided to the display panel 10. Also, in the embodiment of the present invention, if the first light sources 213 emit light to irradiate the light to the 3D light guide plate 211 in the 3D mode, the areas where the first light output patterns 211b are arranged may serve as opening areas OA, and the areas between the first light output patterns 211b may serve as barriers B. That is, in the embodiment of the present invention, in the 3D mode, the backlight unit 210 may serve as the 3D light controller. As a result, in the embodiment of the present invention, a 3D image may be displayed without using the 3D light controller that includes a liquid crystal layer. Therefore, in the embodiment of the present invention, since the 3D image may be displayed by adding the 3D light guide plate 211 and the first light sources 213 only, the manufacturing cost may be reduced as compared with the case where the 3D light controller, which includes a liquid crystal layer, is used.

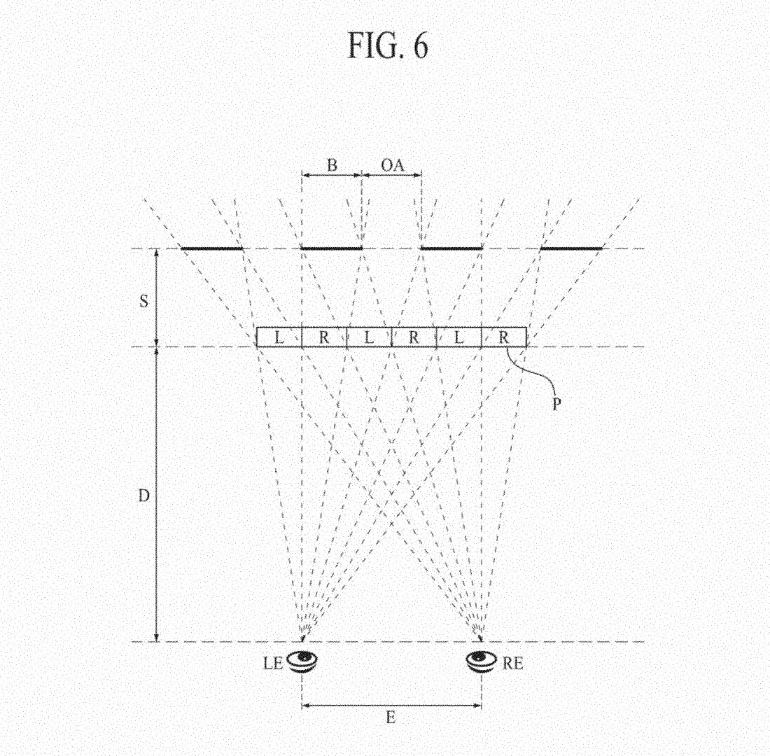

FIG. 6 is an exemplary view illustrating a method for implementing a 3D image in a 3D mode according to the present invention. In FIG. 6, ‘S’ is a rear distance, and denotes a distance from the liquid crystal layer of the display panel 110 to the first light output patterns 211b of the 3D light guide plate 211, OD denotes an optimal viewing distance of a 3D image, and ‘E’ is a distance between both eyes, and may be 65 mm. The optimal viewing distance OD of the 3D image may be designed by a width of the pixel P, the rear distance S, and the distance E between both eyes.

As shown in FIGS. 5B and 5C, if the first light sources 213 emit light in the 3D mode, the light is emitted from the areas where the first light output patterns 211b are arranged. Therefore, if the first light sources 213 emit light to irradiate the light to the 3D light guide plate 211 in the 3D mode, the areas where the first light output patterns 211b are arranged may serve as opening areas OA, and the areas between the first light output patterns 211b may serve as barriers B.

Since the first light output patterns 211b are arranged to be spaced from each other, the opening areas OA and the barriers B are arranged alternately as shown in FIG. 6. Due to arrangement of the opening areas OA and the barriers B, only a left-eye image of the pixels P may be input to a left eye LE of a user and only a right-eye image of the pixels P may be input to a right eye RE of a user, as shown in FIG. 6. Therefore, the user may view a 3D image.

Meanwhile, the width of the opening area OA may be calculated as expressed by the following Equation 3, and the width of the barrier B may be calculated as expressed by the following Equation 4.

$$\begin{matrix}Q = \frac{1 + \frac{B}{P} - \frac{2 R}{E}}{\frac{1}{P} - \frac{1}{E}} & [ Equation 3 ] \\ M = \frac{1 - \frac{B}{P} + \frac{2 R}{E}}{\frac{1}{P} - \frac{1}{E}} & [ Equation 4 ]\end{matrix}$$

In Equation 3 and Equation 4, Q denotes the width of the opening area OA, M denotes the width of the barrier B, P denotes the pitch of the pixel P, B denotes a width of a black matrix, and 2R denotes a viewing margin. In Equation 3 and Equation 4, if

$$\frac{B}{P} and \frac{2 R}{E}$$

are substantially the same as each other, the width Q of the opening area OA and the width M of the barrier B may substantially be the same as each other.

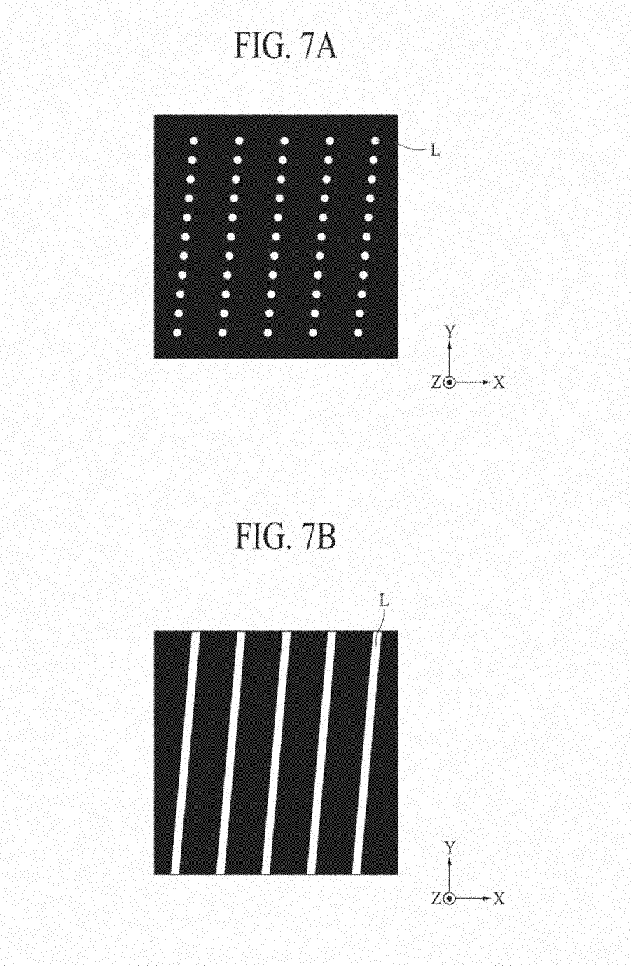

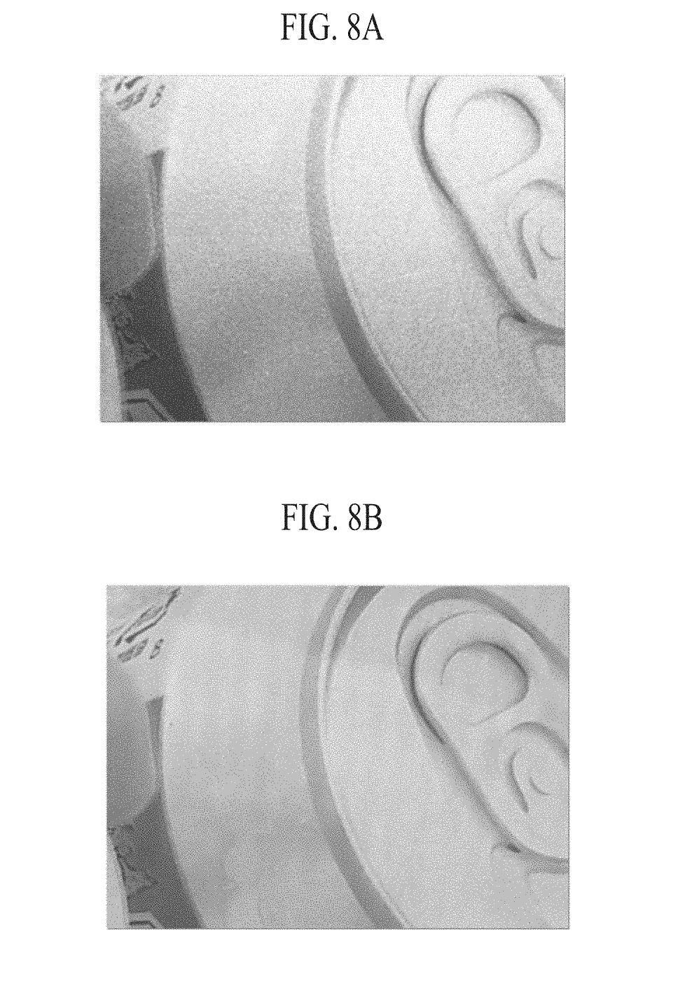

FIGS. 7A and 7B are exemplary views illustrating light output of a backlight unit when a 3D light guide plate does not include lenticular lenses (FIG. 7A) and when the 3D light guide plate includes the lenticular lenses (FIG. 7B). FIGS. 8A and 8B are exemplary views illustrating a 3D image displayed when a 3D light guide plate does not include lenticular lenses (FIG. 8A) and when the 3D light guide plate includes the lenticular lenses (FIG. 8B).

As shown in FIG. 7A, if the 3D light guide plate 211 does not include the lenticular lenses 211c, the backlight unit 210 outputs the light L in a dot type as shown in FIG. 7A. In this case, since the light L is not output between the first light output patterns 211b arranged in a second direction, the light supplied between the pixels of the display panel 110 may be varied. For this reason, luminance between the pixels of the display panel 110 becomes non-uniform. As shown in FIG. 8A, color noise may be visible to a viewer. That is, a problem occurs in that quality of a 3D image is lowered.

However, if the 3D light guide plate 211 includes the lenticular lenses 211c according to an embodiment of the present invention, the light L output to the upper portion of the 3D light guide plate 211 by the first light output patterns 211b parallel with the second direction may be output in a line type parallel with the second direction as shown in FIG. 5B. Therefore, the backlight unit 210 outputs the light L in a line type parallel with the second direction as shown in FIG. 7B. That is, if the 3D light guide plate 211 includes the lenticular lenses 211c according to the embodiment of the present invention, when the light L is output in a dot type as shown in FIG. 7A, a problem that the light L is not output between the first light output patterns 211b arranged in the second direction is not caused. Therefore, according to the present invention, since the light L may uniformly be supplied to the pixels of the display panel 110 between the pixels of the display panel 110, color noise may be prevented from being visible to a viewer due to luminance non-uniformity between the pixels as shown in FIG. 8B.

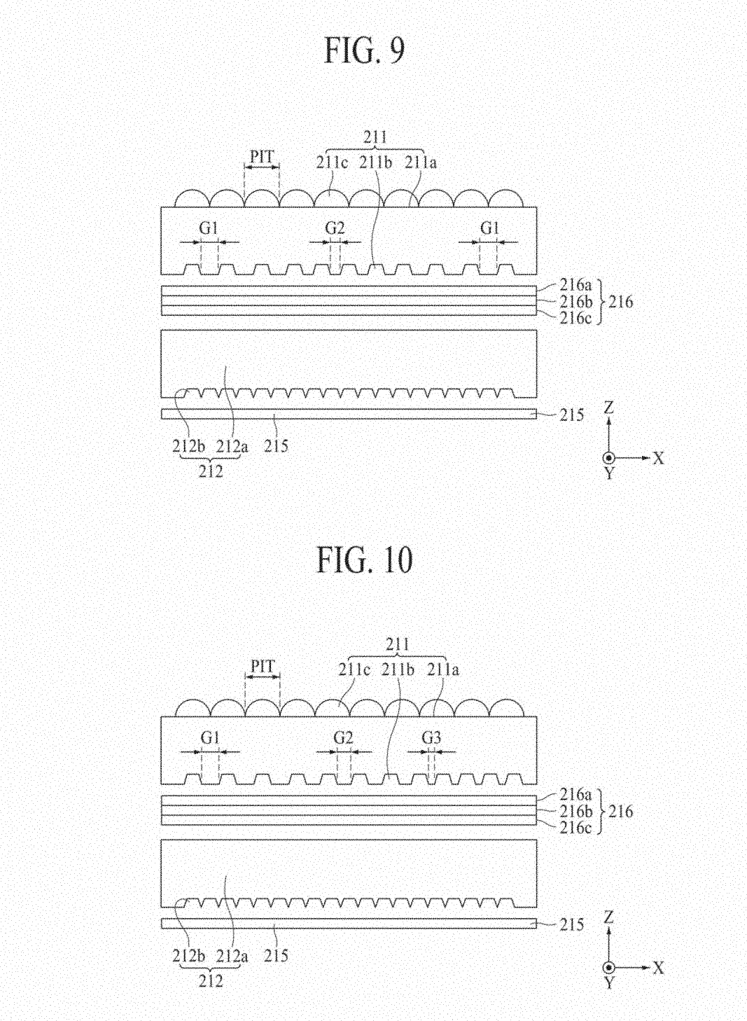

FIG. 9 is a one-side sectional view illustrating another example of the backlight unit of FIG. 3. Sectional views when the backlight unit is viewed in the Y-axis direction of FIG. 3 are shown in FIG. 9.

Referring to FIG. 9, the backlight unit 210 according to another embodiment of the present invention includes a 3D light guide plate 211, a 2D light guide plate 212, first light sources 213, second light sources 214, a reflective sheet 215, optical sheets 216, and first and second light source circuit boards 217 and 218.

The backlight unit 210 shown in FIG. 9 is substantially the same as that described with reference to FIGS. 3, 4 and 5A to 5C, except that an interval between the first light output patterns 211b arranged in the second direction is varied depending on the distance from the first light sources 213. Therefore, other detailed description of the 3D light guide plate 211, the 2D light guide plate 212, the first light sources 213, the second light sources 214, the reflective sheet 215, the optical sheets 216, and the first and second light source circuit boards 217 and 218, which are shown in FIG. 9, will be omitted or may be brief.

Referring to FIG. 9, if the first light sources 213 are arranged at both sides of the 3D light guide plate 211, the interval between the first light output patterns 211b arranged in the second direction may become narrow toward the center from both sides of the 3D light guide plate 211. That is, as shown in FIG. 9, an interval G1 between the first light output patterns 211b at both sides of the 3D light guide plate 211 is wider than an interval G2 between the first light output patterns 211b at the center of the 3D light guide plate 211. That is, the first light output patterns 211b arranged in the second direction may be arranged at the center more densely than at both sides.

When the first light sources 213 are arranged at both sides of the 3D light guide plate 211, if the interval between the first light output patterns 211b arranged in the second direction is uniformly maintained, the light output to the upper portion of the 3D light guide plate 211 may be reduced as the light becomes far away from the first light sources 213. However, as shown in FIG. 9, as the light becomes far away from the first light sources 213, if the interval between the first light output patterns 211b becomes narrow, that is, if the first light output patterns 211b are arranged more densely, the light output to the upper portion of the 3D light guide plate 211 may be prevented from being reduced as the light becomes far away from the first light sources 213.

Meanwhile, as the interval G1 between the first light output patterns 211b at both sides of the 3D light guide plate 211 becomes wider, if the first light output patterns 211b are not arranged within the pitch PIT of the lenticular lens 211c, light loss may necessarily occur in the pitch PIT of the lenticular lens 211c where the first light output patterns 211b are not arranged. Therefore, even though the interval G1 between the first light output patterns 211b at both sides of the 3D light guide plate 211 becomes wider, it is preferable that at least one first light output pattern 211b is arranged within the pitch PIT of the lenticular lens 211c.

As described above, in the embodiment of the present invention, if the first light sources 213 are arranged at both sides of the 3D light guide plate 211, the interval between the first light output patterns 211b arranged in the second direction may become narrow toward the center from both sides of the 3D light guide plate 211. As a result, in the embodiment of the present invention, uniform light may be output in the 3D mode regardless of the distance between the first light output patterns 211b and the first light sources 213.

FIG. 10 is a one-side sectional view illustrating another example of the backlight unit of FIG. 3. Sectional views when the backlight unit is viewed in the Y-axis direction of FIG. 3 are shown in FIG. 10.

Referring to FIG. 10, the backlight unit 210 according to another embodiment of the present invention includes a 3D light guide plate 211, a 2D light guide plate 212, first light sources 213, second light sources 214, a reflective sheet 215, optical sheets 216, and first and second light source circuit boards 217 and 218.

The backlight unit 210 shown in FIG. 10 is substantially the same as that described with reference to FIGS. 3, 4 and 5A to 5C, except that an interval between the first light output patterns 211b arranged in the second direction is varied depending on the distance from the first light sources 213. Therefore, other detailed description of the 3D light guide plate 211, the 2D light guide plate 212, the first light sources 213, the second light sources 214, the reflective sheet 215, the optical sheets 216, and the first and second light source circuit boards 217 and 218, which are shown in FIG. 10, will be omitted or may be brief.

Referring to FIG. 10, if the first light sources 213 are arranged at one side of the 3D light guide plate 211, the interval between the first light output patterns 211b arranged in the second direction may become narrow toward the other side from one side of the 3D light guide plate 211. One side and the other side of the 3D light guide plate 211 face each other. That is, as shown in FIG. 10, an interval G1 between the first light output patterns 211b at one side of the 3D light guide plate 211 is wider than an interval G2 between the first light output patterns 211b at the center of the 3D light guide plate 211. Also, the interval G2 between the first light output patterns 211b at the center of the 3D light guide plate 211 is wider than an interval G3 between the first light output patterns 211b at the other side of the 3D light guide plate 211. That is, the first light output patterns 211b arranged in the second direction may be arranged more densely toward the other side from one side.

When the first light sources 213 are arranged at one side of the 3D light guide plate 211, if the interval between the first light output patterns 211b arranged in the second direction is uniformly maintained, the light output to the upper portion of the 3D light guide plate 211 may be reduced as the light becomes far away from the first light sources 213. However, as shown in FIG. 10, as the light becomes far away from the first light sources 213, if the interval between the first light output patterns 211b becomes narrow, that is, if the first light output patterns 211b are arranged more densely, the light output to the upper portion of the 3D light guide plate 211 may be prevented from being reduced as the light becomes far away from the first light sources 213.

Meanwhile, as the interval G1 between the first light output patterns 211b at one side of the 3D light guide plate 211 becomes wider, if the first light output patterns 211b are not arranged within the pitch PIT of the lenticular lens 211c, light loss may necessarily occur in the pitch PIT of the lenticular lens 211c where the first light output patterns 211b are not arranged. Therefore, even though the interval G1 between the first light output patterns 211b at one side of the 3D light guide plate 211 becomes wider, it is preferable that at least one first light output pattern 211b is arranged within the pitch PIT of the lenticular lens 211c.

As described above, in the embodiment of the present invention, if the first light sources 213 are arranged at one side of the 3D light guide plate 211, the interval between the first light output patterns 211b arranged in the second direction may become narrow toward the other side from one side of the 3D light guide plate 211. As a result, in the embodiment of the present invention, uniform light may be output in the 3D mode regardless of the distance between the first light output patterns 211b and the first light sources 213.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A backlight unit comprising:
a 3D (three-dimensional) light guide plate including first light output patterns and lenticular lenses;
first light sources irradiating light to at least one side of the 3D light guide plate;
a 2D (two-dimensional) light guide plate arranged below the 3D light guide plate; and
second light sources irradiating light to at least one side of the 2D light guide plate,
wherein the lenticular lenses are arranged on the 3D light guide plate.

2. The backlight unit of claim 1, wherein the first light output patterns are arranged on a lower surface of the 3D light guide plate, and include a plurality of trigonal prisms.

3. The backlight unit of claim 1, wherein the first light output patterns are divided into a plurality of groups in accordance with a second direction crossing a first direction along which the first light sources are arranged, and
wherein a light axis of each of the lenticular lenses is parallel with the second direction, and a pitch of each of the lenticular lenses is parallel with a third direction crossing the second direction.

4. The backlight unit of claim 3, wherein at least one light output pattern of each of the plurality of groups is arranged within the pitch of each of the lenticular lenses.

5. The backlight unit of claim 3, wherein the third direction is a direction slanted at a predetermined angle with respect to one side of the 3D light guide plate.

6. The backlight unit of claim 1, wherein, if the first light sources are arranged at both sides of the 3D light guide plate, which face each other, an interval between the first light output patterns at each of the plurality of groups becomes narrow toward a center of the 3D light guide plate from both sides of the 3D light guide plate.

7. The backlight unit of claim 1, wherein, if the first light sources are arranged at one side of the 3D light guide plate, an interval between the first light output patterns at each of the plurality of groups becomes narrow toward the other side of the 3D light guide plate from one side of the 3D light guide plate.

8. An autostereoscopic 3D (three-dimensional) display device comprising:
a display panel; and
a backlight unit irradiating light to the display panel,
wherein the backlight unit includes:
a 3D light guide plate including first light output patterns and lenticular lenses;
first light sources irradiating light to at least one side of the 3D light guide plate;
a 2D (two-dimensional) light guide plate arranged below the 3D light guide plate; and
second light sources irradiating light to at least one side of the 2D light guide plate,
wherein the lenticular lenses are arranged on the 3D light guide plate.

9. The autostereoscopic 3D display device of claim 8, wherein only the second light sources emit light in a 2D mode in which pixels of the display panel display a 2D image through 2D image data, and only the first light sources emit light in a 3D mode in which pixels of the display panel display a 3D image through 3D image data.

10. The autostereoscopic 3D display device of claim 8, wherein the first light output patterns are arranged on a lower surface of the 3D light guide plate, and include a plurality of trigonal prisms.

11. The autostereoscopic 3D display device of claim 8, wherein the first light output patterns are divided into a plurality of groups in accordance with a second direction crossing a first direction along which the first light sources are arranged, and
wherein a light axis of each of the lenticular lenses is parallel with the second direction, and a pitch of each of the lenticular lenses is parallel with a third direction crossing the second direction.

12. The autostereoscopic 3D display device of claim 11, wherein at least one light output pattern of each of the plurality of groups is arranged within the pitch of each of the lenticular lenses.

13. The autostereoscopic 3D display device of claim 11, wherein the third direction is a direction slanted at a predetermined angle with respect to one side of the 3D light guide plate.

14. The autostereoscopic 3D display device of claim 8, wherein, if the first light sources are arranged at both sides of the 3D light guide plate, which face each other, an interval between the first light output patterns at each of the plurality of groups becomes narrow toward a center of the 3D light guide plate from both sides of the 3D light guide plate.

15. The autostereoscopic 3D display device of claim 8, wherein, if the first light sources are arranged at one side of the 3D light guide plate, an interval between the first light output patterns at each of the plurality of groups becomes narrow toward the other side of the 3D light guide plate from one side of the 3D light guide plate.
